(19) United States
(12) Patent Application Publication
(10) Pub. No.: US 2007/0289757 A1
(43) Pub. Date: Dec. 20, 2007

(54) Convertible box blade plow to open V plow

(76) Inventor: Ryan Ashley Wells, Oklahoma City, OK (US)

Correspondence Address: Donald W. Meeker;Patent Agent, #E, 924 East Ocean Front, Newport Beach, CA, 92661, US

(21) Appl. No.: 11/581,432

(22) Filed: Oct. 17, 2006

Related U.S. Application Data
(60) Provisional application No. 60/804,795, filed on Jun. 14, 2006.

(51) Int. Cl. A01B 59/04

(52) U.S. Cl. 172/810

(57) ABSTRACT

A convertible box blade uses hydraulic or manual power to open from the standard box plow into an open V configuration to fill in ditches with a single pass or build terraces or levees. Possible options installed on the V blade include ripper blades to rip up the soil to move or grade, or a landscape rake mounted behind the blade used for finish work.

### CROSS-REFERENCE TO RELATED APPLICATIONS

The present utility patent application claims the benefit of provisional application No. 60/804,795 filed Jun. 14, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to scrapers for moving earth and particularly to an improved split V box blade comprising two box grader blade halves that when closed provide the functionality of a normal box blade, but also provide much greater functionality by using hydraulic or manual power to open the two box halves to an open V configuration to fill in ditches or build terraces or levees.

2. Description of Related Art Including Information Disclosed Under 37 CFR 1.97 and 1.98

The box blade or grader is well known in prior art and has been used to move earth, snow or other material since times when only animals were available to pull the devices. More recently, the box plow or grader has been used with tractors or other earth moving equipment.

None of the prior art provide a box blade which converts to a split V blade useful for a variety of functions including back-filling a trench in one pass pushing piled up soil from both sides of the trench at once.

U.S. Pat. No. 4,802,293, issued Feb. 7, 1989 to Smith, discloses an adjustable earth-moving attachment for use with a vehicle which includes a pair of earth-moving blade assemblies mounted on a main beam. The earth-moving blade assemblies are adapted to be independently movable in several planes with respect to each other and with respect to the main beam so that a plurality of earth-working operations can be performed, and the attachment is amenable for use in conjunction with a wide variety of terrains. The blade assemblies are mounted and designed to efficiently transfer forces with the main beam.

U.S. Pat. No. 6,843,001, issued Jan. 18, 2005 to Jenne, is for a scraper for moving friable material. The scraper includes a frame adapted for attachment to a vehicle and an articulated blade. The blade has left and right portions mounted on the frame for pivoting about a substantially horizontal axis transverse to the articulated blade. Each of the left and right portions of the articulated blade is adapted for pivotal movement about the axis between a substantially horizontal lowered position and a raised position, and each portion is independently positionable in at least one position between the lowered position and the raised position. The articulated blade is positionable for engagement with the friable material as the vehicle travels over the friable material for moving a part of the friable material to shape the friable material in accordance with a predetermined design

U.S. Pat. No. 4,337,833, issued Jul. 6, 1982 to Welch, shows a tiltable box scraper for attachment to a standard three-point hitch at the rear of a farm tractor or the like. The box scraper characterized by having a single hydraulic cylinder mounted thereon for tilting the scraper in opposite directions independently of the position of the tractor on the ground surface.

U.S. Pat. No. 1,637,673, issued Aug. 2, 1927 to Atkins, claims an adjustable ditch maintaining drag which comprises a sled type drag for maintaining the bottom of the ditch which has adjustable blades projecting from the front portion of the drag. U.S. Pat. No. 6,523,620, issued Feb. 25, 2003 to Burson, describes a movable blade for attachment to a material moving machine which is a generally rectangular blade for hinged attachment to a machine shovel, box grader blade or other similar device mounted on the machine. The movable blade angle of extension or retraction relative to the machine is controlled by a hydraulic cylinder, brace or other structural element. When the movable blade is extended outwardly at an angle relative to the machine the machine may be operated parallel to the material to be moved. This action relative to material positioned next to a ditch allows the operator to fill the ditch with material in a continuous operation along the ditch rather than requiring short movements at an angle to the ditch to move the material.

U.S. Pat. No. 6,672,401, issued Jan. 6, 2004 to Crowley, indicates a towable scraper system for contour surface grading. The system includes a rigid chassis member that has a coupler configured for attachment to a conventional three-point tractor hitch. A scraper blade is pivotally suspended from the rigid chassis member and is equipped with a blade motivator for causing an angular rotation of the blade around an axis aligned with a towing direction. A lift assembly raises and lowers the rigid chassis member to control a height of the scraper blade relative to a work surface to be graded. The towable scraper system is provided with a carriage assembly that offers rolling support for the rigid chassis as it moves over the work surface. The carriage assembly is pivotally coupled to the rigid chassis at a location opposed to the coupler and is configured for angular rotation around a second axis aligned with the towing direction.

U.S. Pat. No. 6,168,348, issued Jan. 2, 2001 to Meyer, puts forth a bi-directional surface leveling system that comprises a chassis attachable to a motion source and having a hitch, a grader frame pivotably connected to the hitch and supporting a box grader, and a forward frame pivotably attached to the grader frame and having a caster wheel for supporting the chassis. The box grader holds a bi-directional earth grading tool. Also included is a damping assembly attached to the hitch to dampen upward movement of the grader frame. A powered assembly is pivotably connected at one end to the forward frame and at the opposing end to the grader frame, and a control unit connected to the power assembly selectively extends and retracts the power assembly.

U.S. Pat. No. 4,524,532, issued Jun. 25, 1985 to Browning, concerns a box blade assembly for an earth moving vehicle which has a rotatable semi-cylindrical closure blade. The box blade assembly is used with a tractor with a three point hitch. The box blade includes a pair of spaced parallel side walls, an open front, top, and bottom, and a rear wall having a depending scraper blade attached to the bottom edge thereof. A semi-cylindrical, transversely-extending, closure blade is rotatably mounted on the side walls of the box blade. A fluid-operated cylinder rotates the closure blade from an open position, with the bottom of the box blade open, to a closed position abutting the rear wall and scraper blade enclosing the bottom of the box blade. A vehicle pulls the box blade along the surface of the ground with the scraper blade scraping dirt and confining it within the side and rear walls. The closure blade when rotated to the closed position extends underneath the collected dirt so that it can be lifted with the box blade for transporting to another location. When the closure blade is rotated to the open position, the dirt is dumped from the bottom of the box blade.

U.S. Pat. No. 4,869,326, issued Sep. 26, 1989 to Hutchins, illustrates a box scraper with plural blades having movable moldboards which can be pushed or pulled on a three point hitch. The box blade attachment for tractors and like vehicles comprises a box frame which supports, for pivotal movement, a pair of moldboards, horizontally spaced from each other for scraping a surface in either a forward or backward path. Each of the moldboards moves independently of the other between a first position depending vertically between the sidewalls of the frame, and a second position pivoted inwardly and upwardly to lie in a plane substantially parallel to the surface being scraped. Hydraulic moldboard controls in the preferred embodiment synchronize the movement such that the moldboards move, alternatively and relative to each other, between the first and second positions. Thus arranged the box blade can be used in a conventional manner when the vehicle is moving in either direction by raising the appropriate moldboard and lowering the other.

U.S. Pat. No. 5,172,499, issued Dec. 22, 1992 to Griffin, is for a combination scraper/loader for mounting on the three-point hitch of a tractor which includes a back wall having a forwardly facing scraper blade and a rearwardly facing scraper blade at its lower edge, and two side walls extending from the back wall in spaced parallel relation. A bottom wall is pivotally mounted to the side walls and is operable between a first position at which it closes the bottom face of the scraper/loader, and a second pivoted position at which it opens such bottom face to permit collected dirt to be dumped therefrom. The scraper/loader has a forward set and a rearward set of pivot pins for connection to the tractor in two separate dispositions, and an operating lever for releasing the pivoted bottom wall is provided which can be reached by the operator of the tractor in either disposition of the scraper/loader on the tractor. The pivoted bottom wall may also be entirely removed from the scraper/loader so that it can be used as a conventional box scraper.

U.S. Pat. No. 4,044,843, issued Aug. 30, 1977 to Holub, provides a tractor-mounted scraper in which the scraper blade has two scraping edges and is mounted in a box assembly having two side plates, the blade being mounted on pivots located near the lower edges of the side plates and near the outer edges of the side plates, remote from the tractor. The box assembly is mounted on one end of the tractor, on pivoted arms which are maintained parallel to each other. A power-operated tilting head is mounted rigidly on the parallel arms, and the side plates are rigidly mounted on the moving part of the tilting head by means of a transverse beam, so that the blade neither wanders from side-to-side with respect to the longitudinal axis of the tractor, nor is permitted to tilt with respect to the axis of the pivots by which the attachment is mounted to the tractor, except as permitted by the power-operated tilting head. A hydraulic cylinder is provided for (a) raising the blade and side plates out of contact with the ground, (b) pressing downwardly on the blade and side plate assembly so that the end of the tractor nearest the attachment is supported solely by the blade, and (c) permitting the blade to rest upon the ground, bearing the weight of the side plates, the beam, the tilting head, etc., but not bearing the weight of the tractor, when hydraulic cylinder is in its neutral, unpowered condition. A hydraulic cylinder is also provided for tilting the blade about its pivots, to lower one or the other of blade's two scraping edges.

What is needed is a box blade which converts to a split V blade useful for a variety of functions including back-filling a trench in one pass pushing piled up soil from both sides of the trench at once.

### BRIEF SUMMARY OF THE INVENTION

An object of the present invention is to provide a box blade which converts to a split or open V blade by hydraulic controls to be used for a variety of functions including back-filling a trench in one pass pushing piled up soil from both sides of the trench at once thereby saving time, labor, and costs for fuel and equipment.

In brief, a convertible box blade or V box blade uses hydraulic or manual power to open from the standard box plow configuration into an open V configuration to fill in ditches with a single pass or build terraces or levees. Possible options installed on the V blade include ripper blades to rip up the soil to move or grade, or a landscape rake mounted behind the blade used for finish work.

A primary advantage of the present invention is that the box blade is usable as a box blade and can also quickly convert to an open V configuration which can fill in a ditch with one pass every time.

An associated advantage of the present invention is that it serves multiple purposes.

Another associated advantage of the present invention is that in the V mode, it saves on fuel, machinery wear and tear, and man hours, cutting the job in third or half.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a top plan view of the V box blade frame of the present invention with pivot points, bracing, angle iron, and hydraulic cylinder hook;

FIG. 2 is a side elevational view of the V box blade frame of FIG. 1;

FIG. 3 is a front elevational view of the V box blade frame of FIG. 1;

FIG. 4 is a perspective view of the two-piece V box blade and frame of present invention, illustrating the V box blade frame connected to a tractor, and the two-piece V box blade open into a split V configuration and dragging soil from both sides at once into a trench;

FIG. 5 is a top plan view of a left blade of the two-piece V box blade of FIG. 4;

FIG. 6 is a top plan view of the V box blade and frame of FIG. 4, illustrating the two-piece V box blade in a closed condition in a standard box blade configuration;

FIG. 7 is a top plan view of the two-piece V box blade and frame of FIG. 4, illustrating the V box blade in an opened split V configuration;

FIG. 8 is a perspective side view of the two-piece V box blade and frame of FIG. 4, illustrating the V box blade attached to a tractor in a standard box blade configuration.

### DETAILED DESCRIPTION OF THE INVENTION

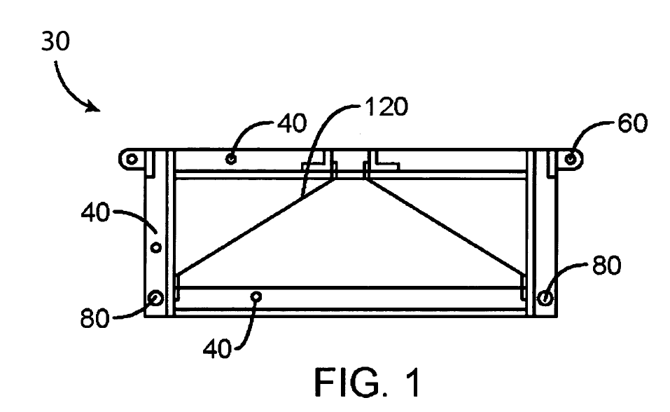

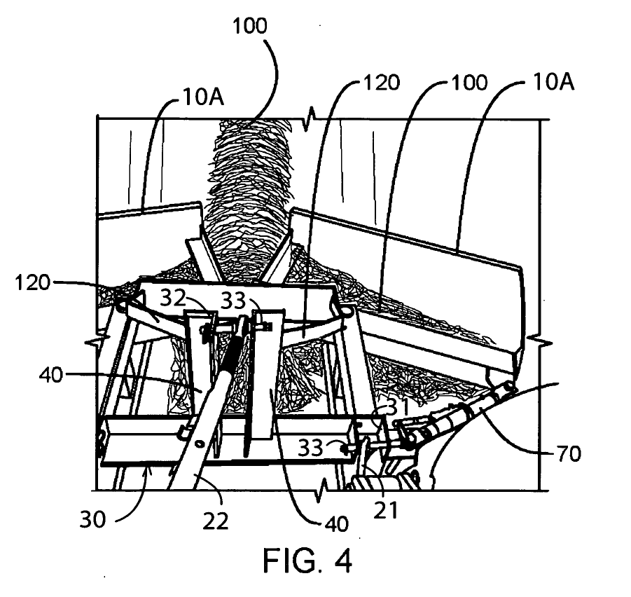

In FIGS. 1-8, a convertible two-piece box blade plow device 10, herein called a V box blade plow alternately coverts from a standard box blade configuration, as shown in FIGS. 6 and 8, to a split V configuration, as shown in FIGS. 4 and 7.

A frame, as shown in FIGS. 1, 2, and 3, is connectable to any tractor either in the front or back, as shown in FIGS. 4 and 8. The frame 30 preferably comprises quick spring loaded pins 33 which to connect the frame 30 to the tractor 20.

Two box plow blade halves 10A and 10B are each pivotally attached by a pivot joint 80 at a point on a front corner of each frame and a point located along the length of each of the V box blades between the two ends with the two box plow blade halves normally aligned side by side so that the two box plow blade halves together form a whole box plow, as shown in FIGS. 6 and 8. The V box plow blade halves 10A and 10B can be either manually or hydraulically lowered and raised.

Two hydraulic cylinders 70 attach with one hydraulic cylinder 70 attached to one half of the blade 10A and the other attached to the other half of the blade 10B for moving the two blade halves from a first configuration with the two blade halves aligned to form a box blade plow, as shown in FIGS. 6 and 8, to a second configuration with the two box blade halves spaced apart and oriented at an angle to each other to form an open V blade plow, as shown in FIGS. 4 and 7.

The frame 30 is configured with two lower side structures 31 to attach to two lower arms 21 of a three point hook up of a tractor 20 and one central upper structure 32 to attach to an upper arm 22 of a three point hook up of the tractor 30.

The frame 30 may be structured to attach to a front end loader of a farm tractor, structured to fit on the front of a farm tractor, a construction tractor, or other construction equipment where a straight blade or dozer blade would normally be attached.

The V box blade device 10 may further comprise ripper blades attached to the front or rear of the two box blade halves 10A and 10B. The frame may be comprised of box tubing having holes cut therein and the ripper blades attached to the frame by notches in the ripper blades wherein different notches rest in the holes in the frame to achieve different depths for the ripper blades. Alternately, the device may further comprise a rotating device attached to the frame wherein the ripper blades are mounted behind the box tubing on the rotating device.

A landscape rake may be attached to the front or rear of the two box blade halves 10A and 10B. Alternately, the device may further comprise a rotating device attached to the frame wherein the landscape rakes are attached to the rotating device behind the box plow blade halves and the landscape rakes are operated either manually or hydraulically to raise and lower them.

In FIGS. 1-8, the convertible box blade plow device 20, herein called a V-box blade, is made up of a frame, as shown in FIGS. 1, 2, and 3, which connects to the 3 point hook-up of a tractor, as shown in FIGS. 4 and 8.

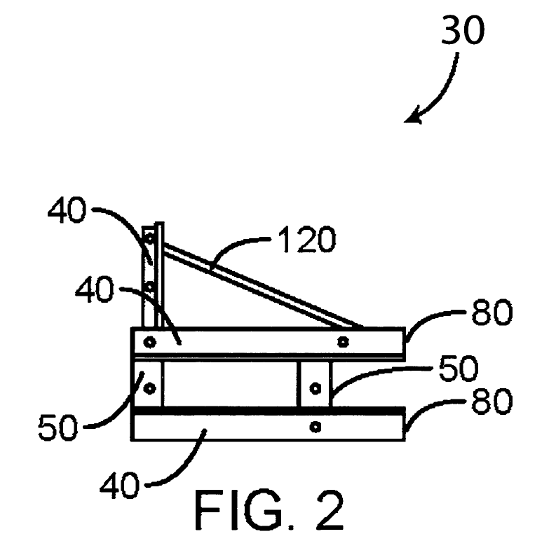

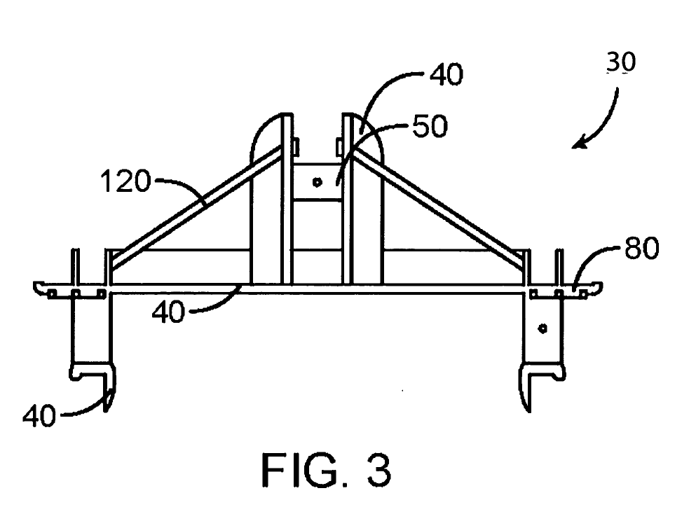

The preferred material to build the frame is out of 4×4 inch structural angles with flat steel for bracing 120, as shown in FIGS. 2 and 3. The frame could also be built out of structural square, rectangle, tees, beam, channel or pipe, preferably up to 8 inches in material size, in all different alloys of metal, such as carbon steels, alloys steels, stainless steels, aluminum alloys, copper alloys, magnesium alloys, titanium alloys, tool steels, nickel, cobalt, and steel.

The preferred size of the frame is 36 inches wide and 28 inches long if looking at FIG. 1 and 24 inches tall if looking at FIG. 3. The frame could also be built in different lengths, widths, and heights, preferably from 6 inches up to 20 feet depending on attachment, blade size which it houses, or the size of the tractor for which it is intended; from a small garden tractor all the way up to a commercial construction tractor.

The bracing 120, as shown in FIGS. 2 and 3, could be made of structural angle, box, rectangular, tees, beam, channel, or pipe, preferably up to 8 inch in material size, all alloys of metal such as carbon steels, alloys steels, stainless steels, aluminum alloys, copper alloys, magnesium alloys, titanium alloys, tool steels, nickel, cobalt, and steel.

On each side of the frame there are steel plates 60 used to bolt the hydraulic cylinders 70. The preferred material is made of ⅜ plate steel welded to the frame, as shown in FIGS. 1 and 6. The plates could be built out of different size sheet metal/plate metal from 20 gauge to 1 inch thick plate, in all different metal alloys, such as carbon steels, alloys steels, stainless steels, aluminum alloys, copper alloys, magnesium alloys, titanium alloys, tool steels, nickel, cobalt, and steel.

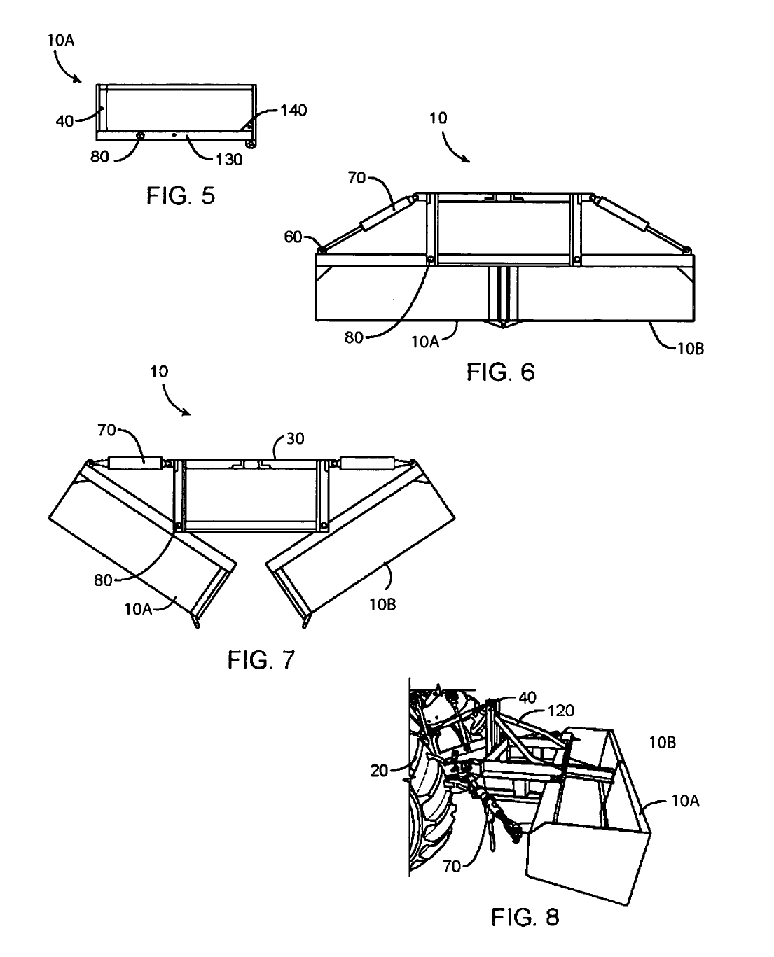

The frame attaches to the two halves of the box blade 10, as shown in FIGS. 5, 6, and 7. The two halves of the box blade pivot on the framework. The preferred way to build the pivot points 80 are out of 2⅜ inch pipe sleeved into 2⅞ inch pipe; however other pipe size can be used. The pivot point could also be built out of round solid stock sleeved into round tubing from 1 inch all the way up to 8 inch in material size. They could be built with different alloys of metal, i.e. hard surface pins and soft bushings such as brass or aluminum or other alloys could be used such as carbon steels, alloys steels, stainless steels, aluminum alloys, copper alloys, magnesium alloys, titanium alloys, tool steels, nickel, cobalt, and steel. On the pivot point 80 there is grease fitting so the operator can grease the pivot points.

The two halves of the blade are asymmetrical as seen in FIGS. 5, 6, and 7. The preferred way to build the end caps are from thick sheet metal and are 24×20 inches, but other thicknesses and sizes could be used. These end caps can be built as short as 6 inches in length and heights, and as long as 10 feet in length and height depending on how much dirt you wanted to carry, or to fit a certain piece of machinery, they could also be built out of different thickness of sheet metal from 20 gauge sheet metal all the way to thick plate, and of all different alloys of metal such as carbon steels, alloys steels, stainless steels, aluminum alloys, copper alloys, magnesium alloys, titanium alloys, tool steels, nickel, cobalt, and steel.

The preferred way to build the back of the blade is from thick sheet metal set 2 inches from the back at the top and 4 inches from the back at the bottom which gives you an 11.25 degree angle. The slope of the blade could be built from a zero all the way to a 45-degree angle, depending on how much dirt you wanted it to cut and carry. The preferred size of the back of one of the blade halves is 42 inches by 20 inches. It could be as short as 6 inches or as long as 20 feet depending on what size of equipment it is intended for use. It could also be as short as 4 inches or as tall 10 feet to hold more or less dirt. It could also be made of a different thickness from 20 gauges sheet metal to thick plate, and all alloys of metal such as carbon steels, alloys steels, stainless steels, aluminum alloys, copper alloys, magnesium alloys, titanium alloys, tool steels, nickel, cobalt, and steel.

At the front of the blade halves, as shown in FIG. 5 #) it has a preferred piece of square tubing 130 which may be 5×5 inch sizes which is welded to the end caps. This could also be built with Structural Square, rectangle, tees, beam, channel or pipe, up to 8-inch inches in material size, in all different alloys of metal such as carbon steels, alloys steels, stainless steels, aluminum alloys, copper alloys, magnesium alloys, titanium alloys, tool steels, nickel, cobalt, and steel.

On the other side of the half there is a preferred piece of 3×3 inch structural angle 40, as shown in FIG. 5, on the other end. The angle iron is also welded to the back of the blade, but could be bolted, or secured by other conventional means. The structural angle could also be built with structural square, rectangle, tees, beam, channel or pipe, up to 8 inches in material size, in all different alloys of metal such as carbon steels, alloys steels, stainless steels, aluminum alloys, copper alloys, magnesium alloys, titanium alloys, tool steels, nickel, cobalt, and steel. The preferred place to put box tubing is welded 3 inches down from the top of the end cap, and could also be bolted. It could be placed anywhere from the bottom of the blade to the top of the blade. Housed in the box tubing is the pivot point 80, which connects the two halves of the V box blade to the frame, as shown in FIGS. 6, and 7. The box tubing could also be replaced with structural angle iron, pipe, or rectangular tubing, all alloys of metal such as carbon steels, alloys steels, stainless steels, aluminum alloys, copper alloys, magnesium alloys, titanium alloys, tool steels, nickel, cobalt, and steel. The angle iron running from the box tubing to the back of the blade could preferably be replaced with structural box, rectangle, tees, beam, channel, or pipe all the way up to 8 inch.

At the bottom of the back of the blade there is a smaller 4 inch blade that bolts on using carriage bolts so that this blade is replaceable due to wearing. It is a hardened steel scraper blade. It could be built from different hardened alloys such as carbon steels, alloys steels, stainless steels, aluminum alloys, copper alloys, magnesium alloys, titanium alloys, tool steels, nickel, cobalt, and steel, and attached with different sizes bolts all the way up to 1 inch, or it could be welded on, or secured by other conventional means.

On the outer side of each half of the V box blade there is a ⅜ plate 60 welded to hook up the hydraulic cylinders, as shown in FIGS. 1 and 6. It could be preferably be built out of different size sheet metal from 20 gauges sheet metal to 1 inch steel plate. All alloys of metal such as carbon steels, alloys steels, stainless steels, aluminum alloys, copper alloys, magnesium alloys, titanium alloys, tool steels, nickel, cobalt, and steel.

Other than the pivot points 80, as shown in FIGS. 6 and 7, the two halves of the V box blade attach to the frame with 2 hydraulic cylinders 70 attached at the front corner of the frame to the ⅜ plate 60 on the front outside of the V box blade half, as shown in FIG. 6.

The hydraulic hoses from each cylinder 70 go to a common T so both halves can be operated with one lever in the tractor; however, it could be hooked up where each half works separate utilizing two levers in the tractor, one for each half. For tractors without hydraulic power it can be equipped with a hand powered ratchet screw type cylinder or other mechanical means to either hold the halves open or closed.

In use, when the operator chooses to close the V-box blade it operates like a normal box blade, as shown in FIGS. 6 an 8, used for grading uneven surfaces, moving dirt, digging wide ditches, grading roads, landscaping, etc. When the operator chooses to open the V-box blade via hydraulic power or manual power, as shown in FIGS. 4 and 7, it opens in the back in the shape of a split V which channels the dirt to an area roughly a foot wide. The V-box blade is used for filling in ditches, as shown in FIG. 4. A traditional angle blade requires you to drive the equipment along each side of the ditch to fill it in; taking 2, and sometimes 3 passes to get the job done. With the V-box blade of the present invention the wheels of the tractor, machinery, or equipment straddle the ditch. This unique structure of the present invention allows the operator to fill in the ditch on each side with one pass; thus saving the owner/operator fuel cost and labor-hours.

The V-box blade can also be used to build small terraces and levees to convert water drainage problems. The V-box blade will channel dirt in the center therefore making a small or large terrace depending on how many passes the operator chooses to make wherever the operator chooses, which is excellent for converting water drainage. It also works great for grading roads. A traditional box blade digs a hole where your road is, and scrapes a flat area allowing dirt to escape on both sides which makes your road lower than your bar ditches which fills up with water when it rains. The V-box blade of the present invention actually builds up the center of the road by moving the dirt to the center and cutting the sides of the road allowing proper drainage of your roads. An operator can make several passes down the road with the V-box blade open moving more and more dirt to the center with each pass. Then the operator can close the V-box blade and smooth out the road (with all the dirt in the center). This allows proper drainage and no more standing water holes in the roads

The V-box blade and frame could be structured differently. A person skilled in the art could take a straight blade without the sides and make it open to a V. A person skilled in the art could also make the design to be pushed by the tractor fitted where a dozer blade would go, or on a front end loader of a tractor, instead of pulled behind the tractor. While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustrations only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

What is claimed is:

1. A convertible box blade plow device to covert from the normal box blade made mode to a V-box blade, the device comprising:
a frame connectable to any tractor either in the front or back;
two box plow blade halves each pivotally attached to a front of the frame with the two box plow blade halves normally aligned side by side so that the two box plow blade halves form a whole box plow;
two hydraulic cylinders comprising one hydraulic cylinder attached to one half of the blade and the other attached to the other half of the blade for moving the two blade halves from a first position with the two blade halves aligned to form a box blade plow to a second position with the two box blade halves spaced apart and oriented at an angle to each other to form an open V blade plow.

2. The device of claim 1 wherein the frame is configured with two lower side structures to attach to two lower arms of a three point hook up of a tractor and one central upper structure to attach to an upper arm of a three point hook up of the tractor.

3. The device of claim 1 wherein the frame is structured to attach to a front end loader of a farm tractor.

4. The device of claim 1 wherein the frame is structured to fit on the front of a farm tractor, a construction tractor, or other construction equipment where a straight blade or dozer blade would normally be attached.

5. The device of claim 1 further comprising ripper blades attached to the front or rear of the two box blade halves.

6. The device of claim 5 wherein the frame is comprised of box tubing having holes cut therein and the ripper blades are attached to the frame by notches in the ripper blades wherein different notches rest in the holes in the frame to achieve different depths for the ripper blades.

7. The device of claim 5 further comprising a rotating device attached to the frame wherein the ripper blades are mounted behind the box tubing on the rotating device.

8. The device of claim 7 wherein the box plow blade halves can be either manually or hydraulically lowered and raised.

9. The device of claim 1 further comprising a landscape rake attached to the front or rear of the two box blade halves.

10. The device of claim 9 further comprising a rotating device attached to the frame wherein the landscape rakes are attached to the rotating device behind the box plow blade halves and the landscape rakes are operated either manually or hydraulically to raise and lower them.

11. The device of claim 1 further comprising quick spring loaded pins to connect the frame to the tractor.
